(19) United States
(12) Patent Application Publication
(10) Pub. No.: US 2024/0378770 A1
(43) Pub. Date: Nov. 14, 2024

(54) IMAGE PROCESSING METHOD AND APPARATUS, ELECTRONIC DEVICE, AND READABLE STORAGE MEDIUM

(71) Applicant: BEIJING ZITIAO NETWORK TECHNOLOGY CO., LTD., Beijing (CN)

(72) Inventor: Xingzhe CHEN, Beijing (CN)

(21) Appl. No.: 18/690,653

(22) PCT Filed: Sep. 6, 2022
(86) PCT No.: PCT/CN2022/117202

§ 371 Date: Mar. 8, 2024

(30) Foreign Application Priority Data
Sep. 10, 2021 (CN) 202111062470.7

(51) Int. Cl. G06T 11/00; G06T 5/92

(52) U.S. Cl. CPC G06T 11/001; G06T 5/92; G06T 2207/10024; G06T 2207/20208

(57) ABSTRACT

The present disclosure relates to an image processing method, apparatus, electronic device and readable storage medium, wherein the method acquires a first texture data of a target effect in a first color display standard based on a trigger of a user for the target effect in a practical application scene; executes a texture conversion on the first texture data based on a second color display standard, thereby acquiring a converted second texture data; then displays the target effect according to the second texture data. The method provided by the present disclosure realizes the adaptation of the target effects of the first color display standard and the image materials of the second color display standard by executing an online texture conversion on the target effects of the first color display standard.

The present application claims the priority to Chinese Patent Application No. 202111062470.7, entitled “Image processing method and device, electronic equipment and readable storage medium” filed on Sep. 10, 2021, which is incorporated herein by reference in its entirety.

### TECHNICAL FIELD

The present disclosure relates to a technical field of image processing, in particular to an image processing method, apparatus, electronic device and readable storage medium.

### BACKGROUND

With continuous development of display technology, users' demand for image display is getting higher and higher. Therefore, color display standards to meet users' higher display needs are put forward. An intelligent terminal also support the shooting of photos and videos with high color display standards. Because photos and videos with the high color display standards may present more light and dark details and more colors, and may restore the real scene to the greatest extent, they are favored by the majority of users. With continuous development of computer technology, the functions of the intelligent terminal are becoming more and more abundant. The intelligent terminal support the use of filters, stickers and other effects in the process of shooting photos or videos, so as to obtain richer shooting effects. The intelligent terminal also supports editing the already shot image material, for example, adding the effects such as filters and stickers.

At present, in order to adapt to the image material of high color display standard, it is necessary to convert the effects made in low color display standard into those in high color display standard.

In the prior art, an offline conversion method is usually adopted, that is, the effects in the low-color display standard are converted to the effects in the high-color display standard offline. However, the offline conversion is inefficient. Therefore, how to improve a conversion efficiency is an urgent problem to be solved.

### SUMMARY

In order to solve or at least partially solve the above technical problems, the present disclosure provides an image processing method, apparatus, electronic device and readable storage medium.

In a first aspect, the present disclosure provides an image processing method, comprising:
acquiring a first texture data corresponding to a target effect in response to a triggering operation to the target effect, wherein the first texture data is a texture data of the target effect corresponding to a first color display standard;
executing a texture conversion on the first texture data according to a second color display standard to acquire a second texture data; wherein a color range of the second color display standard is larger than a color range of the first color display standard; and
displaying the target effect according to the second texture data.

In some possible embodiments, the executing the texture conversion on the first texture data according to the second color display standard to acquire the second texture data, comprises:
acquiring a target output format of the target effect in the second color display standard, wherein the second color display standard corresponds to one or more output formats, and the one or more output formats comprise the target output format; and
executing the texture conversion on the first texture data according to the target output format to acquire the second texture data.

In some possible embodiments, the executing the texture conversion on the first texture data according to the target output format to acquire the second texture data, comprises:
acquiring a conversion function corresponding to the target output format according to the target output format;
executing the texture conversion on the first texture data according to the conversion function corresponding to the target output format to acquire the second texture data.

In some possible embodiments, before displaying the target effect according to the second texture data, further comprises:
configuring a data type identifier corresponding to the second texture data; and
acquiring the second texture data according to the data type identifier of the second texture data.

In some possible embodiments, the executing the texture conversion on the first texture data according to the second color display standard to acquire the second texture data, comprises:
executing the texture conversion on part of the first texture data according to the second color display standard to acquire the second texture data; and
the displaying the target effect according to the second texture data, comprises:
displaying the target effect according to a texture data without the texture conversion in the first texture data and the second texture data.

In some possible embodiments, before the displaying the target effect according to the texture data without the texture conversion in the first texture data and the second texture data, further comprises:
respectively configuring data type identifiers corresponding to the texture data without the texture conversion in the first texture data and the second texture data; and
acquiring the texture data without the texture conversion in the first texture data and the second texture data according to the data type identifiers corresponding to the texture data without the texture conversion in the first texture data and the second texture data respectively.

In some possible embodiments, the method further comprises:
acquiring a first constant parameter corresponding to the target effect;
converting the first constant parameter into a second constant parameter according to the second color display standard; and
the displaying the target effect according to the second texture data, comprises:
displaying the target effect according to the second texture data and the second constant parameter.

In some possible embodiments, the converting the first constant parameter into the second constant parameter according to the second color display standard, comprises:
converting the first constant parameter into the second constant parameter according to a conversion function corresponding to the target output format of the target effect in the second color display standard.

In some possible embodiments, the first color display standard comprises a Standard Dynamic Range (SDR) color display standard, and the second color display standard comprises a High Dynamic Range (HDR) color display standard.

In a second aspect, the present disclosure provides an image processing apparatus comprising:
an acquisition module, configured to acquire a first texture data corresponding to a target effect in response to a triggering operation to the target effect, wherein the first texture data is a texture data of the target effect corresponding to a first color display standard;
a texture conversion module, configured to execute a texture conversion on the first texture data according to a second color display standard to acquire a second texture data; wherein the color range of the second color display standard is larger than a color range of the first color display standard; and
a display module, configured to display the target effect according to the second texture data.

In a third aspect, the present disclosure provides an electronic device comprising: a memory and a processor, wherein
the memory is configured to store computer program instructions; and
the processor is configured to execute the computer program instructions to cause the electronic device to realize the image processing method according to any one of the first aspects.

In a fourth aspect, the present disclosure provides a readable storage medium comprising: computer program instructions, wherein the computer program instructions when executed by at least a processor of an electronic device to implement the image processing method according to any one of the first aspects.

In a fifth aspect, the present disclosure provides a program product, comprising: computer program instructions, wherein the computer program instructions are stored in a readable storage medium, and at least a processor of an electronic device can read the computer program instructions from the readable storage medium, and the at least one processor executes the computer program instructions to enable the electronic device to realize the image processing method according to any one of the first aspects.

The invention provides an image processing method, apparatus, electronic device and readable storage medium, wherein the method acquires a first texture data of a target effect corresponding to a first color display standard based on a user's triggering operation to the target effect in a practical application scene; executes a texture conversion on the first texture data based on a second color display standard, thereby acquiring a converted second texture data; then displays the target effect through the second texture data. The method provided by the present disclosure realizes the adaptation of the target effect of the first color display standard and the image material of the second color display standard by executing an online texture conversion on the target effect of the first color display standard; compared with an offline conversion, this scheme may save lots of the offline conversion workloads and improve processing efficiency; and this scheme will not have any impact on the use of effects currently deployed online.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure.

In order to explain the technical scheme in the embodiment of the present disclosure or the prior art more clearly, the drawings needed in the description of the embodiment or the prior art will be briefly introduced below. Obviously, for ordinary people in the field, other drawings may be obtained according to these drawings without paying creative labor.

FIG. 1 is a flowchart of an image processing method provided by an embodiment of the present disclosure;

FIG. 2 is a flowchart of an image processing method provided by another embodiment of the present disclosure;

FIG. 3 is a flowchart of an image processing method provided by another embodiment of the present disclosure;

FIG. 4 is a flowchart of an image processing method provided by another embodiment of the present disclosure;

FIG. 5 is a structural diagram of an image processing apparatus provided by an embodiment of the present disclosure; and

FIG. 6 is a schematic structural diagram of an electronic device provided by an embodiment of the present disclosure.

### DETAILED DESCRIPTION

In order to understand the above objects, features and advantages of the present disclosure more clearly, the scheme of the present disclosure will be further described below. It should be noted that the embodiments of the present disclosure and the features in the embodiments may be combined with each other without conflict.

In the following description, many specific details are set forth in order to fully understand the present disclosure, but the present disclosure may be practiced in other ways than those described herein; obviously, the embodiments in the specification are only part of the embodiments of the present disclosure, not all of them.

Illustratively, the present disclosure provides an image processing method, apparatus, electronic device, readable storage medium and computer program product, which acquire a first texture data of a target effect corresponding to a first color display standard based on a user's triggering operation to the target effect in a practical application scene; execute a texture conversion on the first texture data based on a second color display standard, thereby acquiring a converted second texture data; then display the target effect through the second texture data. The method provided by the present disclosure realizes the adaptation of the target effect of the first color display standard and the image material of the second color display standard by executing an online texture conversion on the target effect of the first color display standard; compared with an offline conversion, this scheme may save lots of the offline conversion workloads and improve processing efficiency; and this scheme will not have any impact on the use of effects currently deployed online.

The present disclosure does not limit the first color display standard and the second color display standard, wherein a color range of the first color display standard may be smaller than a color range of the second color display standard. For example, the first color display standard comprises a Standard Dynamic Range (SDR) color display standard, and the second color display standard comprises a High Dynamic Range (HDR) color display standard.

The image processing method of the present disclosure is executed by an electronic device. The electronic device may be a tablet computer, a mobile phone (such as a folding screen mobile phone, a large screen mobile phone, etc.), a wearable device, a vehicle-mounted device, an augmented reality (AR)/virtual reality (VR) device, a notebook computer, an ultra-mobile personal computer, UMPC), a netbook, a personal digital assistant (PDA), a smart TV, a smart screen, a high-definition TV, a 4K TV, a smart speaker, a smart projector and an internet of things (IOT) device. The present disclosure does not impose any restrictions on a specific type of the electronic device.

Based on the foregoing description, the following embodiments of the present disclosure will take the electronic device as an example, and take the first color display standard as the SDR color display standard and the second color display standard as the HDR color display standard as examples, and combine the attached drawings and application scenarios to elaborate the image processing method provided by the present disclosure in detail.

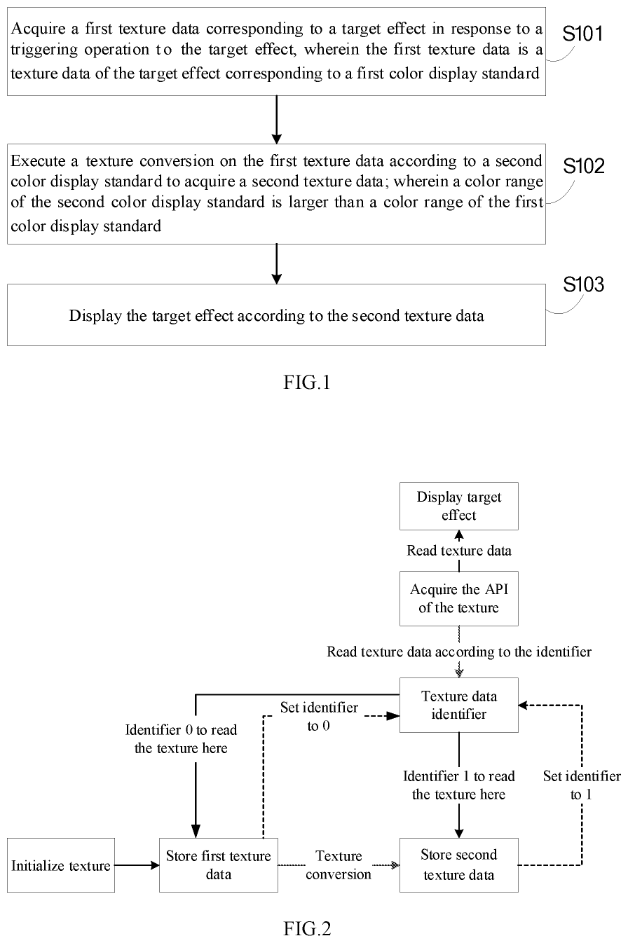

FIG. 1 is a flowchart of an image processing method provided by an embodiment of the present disclosure. FIG. 2 is a flowchart of an image processing method provided by another embodiment of the present disclosure.

Referring to FIG. 1, the method provided by this embodiment includes:

S101: acquiring a first texture data corresponding to a target effect in response to a triggering operation to the target effect, wherein the first texture data is a texture data of the target effect corresponding to a first color display standard.

The electronic device may acquire the triggering operation to the target effect. Wherein, the triggering operation to the target effect may be realized by the user clicking on an area on a display screen of the electronic device where the relevant information of the target effect is displayed; or the triggering operation to the target effect may also be realized by the user by operating an external input device (such as a keyboard, a mouse, etc.) to operate an area on the display screen of the electronic device that displays the relevant information of the target effect. The present disclosure does not limit the implementation of triggering target effects.

The target effect may include, but are not limited to, a static text sticker, a dynamic text sticker, a static picture sticker, a dynamic picture sticker and so on. The present disclosure does not limit size, content, color and other parameters of the target effect.

The electronic device may respond to the triggering operation to the target effect.

One possible implementation is that if all resource packages corresponding to the effects are deployed on a server device, the electronic device may acquire the resource packages corresponding to the target effects (or may also be called configuration files) from the server device, and parse the resource packages corresponding to the target effects; after initializing the texture, the texture data of the target effect is loaded into a memory of the electronic device, so as to acquire the first texture data of the target effect in the SDR color display standard.

Another possible implementation is that if the electronic device caches the resource package with the target effect in advance, the electronic device may read the resource package corresponding to the target effect from a cache space and parse the resource package of the target effect; after initializing the texture, the texture data of the target effect is loaded into the memory of the electronic device, so as to acquire the first texture data of the target effect in the SDR color display standard.

S102: executing a texture conversion on the first texture data according to a second color display standard to acquire a second texture data; wherein a color range of the second color display standard is larger than a color range of the first color display standard.

Compared with the first color display standard, the second color display standard has a wider color range, or it may be understood that the second color display standard has a wider color gamut and may represent more colors than the first color display standard. If the effects in the first color display standard are directly displayed in the second color display standard, there may be an abnormal display of the effects, such as an abnormal color. Therefore, in the present disclosure, the purpose of online texture conversion by the electronic device is to align the color of the target effect in the first color display standard to the second color display standard.

In one possible implementation, the electronic device may execute the texture conversion on the first texture data based on the target output format of the target effect in the second color display standard to acquire the second texture data. In practical applications, color display standards usually include multiple output formats, and each output format corresponds to a different conversion function. Therefore, the electronic device needs to execute the texture conversion based on a conversion function of a corresponding output format when executing the texture conversion. Specifically, according to the target output format, the conversion function corresponding to the target output format is acquired; using the conversion function corresponding to the target output format, the first texture data is transformed to acquire the second texture data corresponding to the second color display standard of the target effect.

The second color display standard corresponds to one or more output formats, and the one or more output formats corresponding to the second color display standard comprise the target output format.

Wherein, the conversion function may comprise: an electro-optical conversion function, a color space conversion function and a photoelectric conversion function, etc. The conversion functions corresponding to the output formats corresponding to the second color display standard may be preconfigured in the electronic device, and when the electronic device executes online texture conversion, it may query preconfigured conversion functions corresponding to the output formats based on the target output format to acquire the conversion functions corresponding to the target output format.

The target output format may be preset, or it may also be determined by the electronic device according to input instructions from other modules or components, such as display modules.

Taking the first color display standard as the SDR color display standard and the second color display standard as the HDR color display standard as an example, the process of the texture conversion for the first texture data will be exemplarily explained. Illustratively, the following steps may be comprised:
Step a: the electro-optical conversion.

Based on the electro-optical conversion function corresponding to the target output format, the first texture data is converted from the nonlinear space of the electrical signal to the linear space of the optical signal, such as the linear space here, such as a linear 709 color gamut space.
Step b: the color space conversion.

Based on the color space conversion function corresponding to the target output format, the color data in the linear 709 color gamut space corresponding to the SDR color display standard is multiplied by the color space conversion function corresponding to the target output format, so as to be converted into a linear 2020 color gamut space corresponding to the HDR color display standard.
Step c: the photoelectric conversion.

Based on the photoelectric conversion function corresponding to the target output format of the HDR color display standard, the optical signal in the linear 2020 color gamut space corresponding to the HDR color display standard is converted into a nonlinear electrical signal.

Assuming that the second color display standard is the HDR color display standard, the target output format may be but not limited to a HLG (Hybrid Log-Gamma) format, a PQ (Perceptual Quantizer) format, etc. Wherein, the process of texture conversion is similar when the target output format is the HLG format or the PQ format, but the difference is that the conversion function is different.

Optionally, step S102 may perform the texture conversion on all the data of the first texture data, or may execute the texture conversion on some data of the first texture data, which is related to the actual situation of the target effect.

For example, assuming that all the pictures of the target effect are used for display, all the texture data of the target effect need to be converted; assuming that some pictures in the target effect are used for display and some pictures are used for storing data information (for example, a dictionary lookup table is stored), the portion of texture data corresponding to the image used for display in this effect needs to be converted, and no conversion is performed on the image that stores the data information.

Therefore, whether all the texture data or part of the texture data of the target effect is transformed depends on the actual situation.

S103: displaying the target effect according to the second texture data.

The electronic device may read the second texture data from the memory based on a packaged application program interface (API) for acquiring the texture data, render according to the second texture data, and display the target effect.

Illustratively, on the basis of the embodiment shown in FIG. 1, combined with FIG. 2:

The electronic device obtains the resource package of the target effect and parses the resource package, initializes the texture, and then loads the first texture data acquired by parsing into the memory. In practical application, corresponding memory resources may be allocated for the first texture data, and this part of the memory resources may be marked as a first memory space.

It should be understood that other data besides the texture data comprised in the resource package of the target effects are also loaded into the memory.

Through the texture conversion of the first texture data, a converted second texture data is acquired, and the electronic device allocates corresponding memory resources for the second texture data, which may be marked as a second memory space.

Configuring a data type identifier of the first texture data in the first memory space as a first identifier. Illustratively, the first identifier may be a digital identifier 0. Configuring a data type identifier of the second texture data in the second memory space as a second identifier. Illustratively, the second identifier is a digital identifier 1.

If all the first texture data are subjected to texture conversion, the API for acquiring the texture data is configured according to the corresponding second identifier of the second texture data. The electronic device accesses and reads the second texture data through the configured API for acquiring the texture data; and displaying the target effect according to the second texture data and other relevant information in the resource package corresponding to the target effect.

If a part of the first texture data is subjected to texture conversion, corresponding data type identifiers may be configured for the texture data which are not subjected to texture conversion in the first texture data and the second texture data respectively; acquiring the texture data and the second texture data in the first texture data without the texture conversion according to the data type identifiers respectively corresponding to the texture data and the second texture data in the first texture data. For example, the API for acquiring the texture data is configured according to the first identifier corresponding to data that is not subjected to texture conversion in the first texture data and the second identifier corresponding to the second texture data. The electronic device reads the data without the texture conversion in the first texture data from the first memory space through the configured API for an acquiring texture data, and the electronic device reads the second texture data from the second memory space through the configured API for acquiring the texture data; and display the target effect according to the data without the texture conversion in the first texture data, the second texture data and other relevant information in the resource package corresponding to the target effect.

In some embodiments, the API for the acquiring textures may be configured by storing the data type identifier of the texture data related to the target effects in a class (which may also be understood as an object), and the API interface may acquire a memory address of the texture data to be read based on accessing the object, and acquire the corresponding texture data based on the acquired memory address.

In the example shown in FIG. 2 above, the class for storing the data type identifier is encapsulated in the API for acquiring the texture; in practical application, the class used to store the data type identifier may also be set separately, that is, it is not bound to the API. In this case, the API for the acquiring texture acquires identifier information by accessing the class for storing the data type identifier. The present disclosure does not restrict whether the class for storing the data type identifier is bound to the API for the acquiring texture.

The method provided by this embodiment acquires a first texture data of a target effect in the first color display standard based on a trigger of the user for the target effect in the actual application scene; executing a texture conversion on the first texture data based on a second color display standard, thereby acquiring a converted second texture data; then displays the target effect through the second texture data. The method provided by the present disclosure realizes the adaptation of the target effect of the first color display standard and the image material of the second color display standard by executing an online texture conversion on the target effect of the first color display standard; compared with an offline conversion, this scheme may save lots of offline conversion workloads, improve processing efficiency, and will not cause damage to the user; In addition, this scheme will not have any impact on the effects currently deployed online.

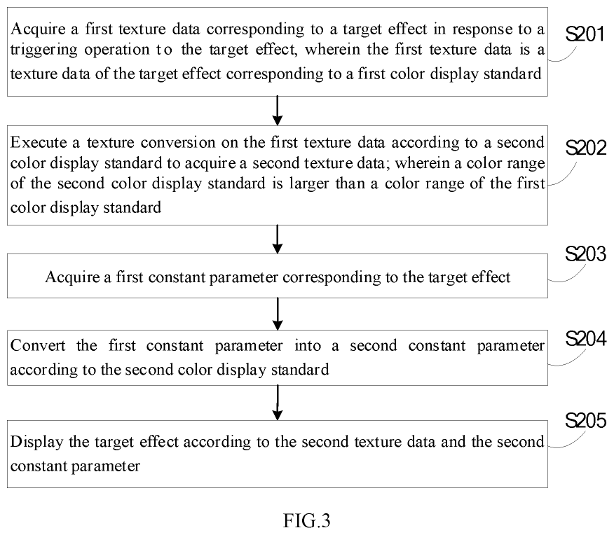

FIG. 3 is a flowchart of an image processing method provided by another embodiment of the present disclosure. Referring to FIG. 3, the image processing method provided by this embodiment comprises:

S201: acquiring a first texture data corresponding to a target effect in response to a triggering operation to the target effect, wherein the first texture data is a texture data of the target effect corresponding to a first color display standard.

S202: executing a texture conversion on the first texture data according to a second color display standard to acquire a second texture data; wherein a color range of the second color display standard is larger than a color range of the first color display standard.

Steps S201 and S202 in this embodiment are similar to steps S101 and S102 in the embodiment shown in FIG. 1, respectively, and are not repeated here for brevity.

S203: acquiring a first constant parameter corresponding to the target effect.

S204: converting the first constant parameter into a second constant parameter according to the second color display standard.

The resource package of the target effects usually comprises constant parameters. For example, in a text sticker, a color of the text may be set in a form of a constant parameter. If this kind of constant parameter (i.e. the first constant parameter) which affects the display effect of the target effect is not converted, the display of the target effect will be abnormal.

The resource package of the target effect and each parameter comprised in the resource package may be provided with corresponding identifier information, and the electronic device may parse the resource package of the target effect to acquire which parameters are the constant parameters and which the constant parameters are the first constant parameters that need to be converted.

For example, the electronic device acquires the resource package of the target effect, determines that the target effect is a text sticker effect through parsing, and further determines the constant parameter and the first constant parameter to be converted according to the identification information corresponding to the data by parsing the data in the resource package of the text sticker effect.

Based on the above description, the electronic device may convert the first constant parameter based on the second color display standard to acquire the second constant parameter corresponding to the first constant parameter. Similar to the texture conversion, the electronic device may convert the first constant parameter based on the conversion function corresponding to the target output format.

Exemplarily, the first constant parameter is used to represent a corresponding text color of the text sticker for example. Assuming that the electronic device determines that the color selected by the user is red based on a color selection instruction for the text sticker input by the user, an RGB value of the text color corresponding to the text sticker is (1,0,0), so the RGB value of the text color corresponding to the text sticker may be stored at a constant (1,0,0).

It should be understood that the same RGB value will be displayed as a different color in the SDR color display standard and the HDR color display standard because the color ranges of the two color display standards are different, e.g., an RGB value of (1,0,0) is a different red color in the SDR color display standard and the HDR color display standard, and a text sticker will be displayed as a different red color if the text is displayed in the HDR color display standard based on the read constant (1,0,0) of the color of the text used for the representation.

Therefore, the electronic device may acquire the conversion function corresponding to the target output format based on the target output format of the text sticker in the HDR color display standard; and convert the RGB value based on the conversion function to acquire the converted RGB value.

Of course, the resource package of the target effects may also comprise other constant parameters that need to be converted, which are not limited to the above constant parameters that represent the text color, and are only examples here; in addition, for different first constant parameters, the conversion functions may be the same or different, which may be determined according to specific conditions, and this disclosure does not limit this.

It should be noted that in this embodiment, the conversion of the first texture data and the conversion of the first constant parameter are executed in no particular order.

S205: displaying the target effect according to the second texture data and the second constant parameter.

Specifically, the electronic device may read the second texture data from the memory based on the packaged application program interface (API) for acquiring the texture data; and acquire the second constant parameter from that memory, render according to the second texture data and the second constant parameter, and display the target effect.

The method provided by this embodiment acquires a first texture data of a target effect in the first color display standard based on the trigger of the user for the target effect in an actual application scene; executing a texture conversion on a first texture data based on a second color display standard, thereby acquiring a converted second texture data; then displays the target effect through the second texture data. The method provided by the present disclosure realizes the adaptation of the target effect of the first color display standard and the image material of the second color display standard by executing an online texture conversion on the target effect of the first color display standard; compared with an offline conversion, this scheme may save lots of offline conversion workloads, improve processing efficiency, and will not affect the performance of electronic device; in addition, this scheme will not have any impact on the use of effects currently deployed online.

Moreover, this embodiment improves the accuracy of the conversion of the target effects from the first color display standard to the second color display standard by converting the constant parameters of the target effects.

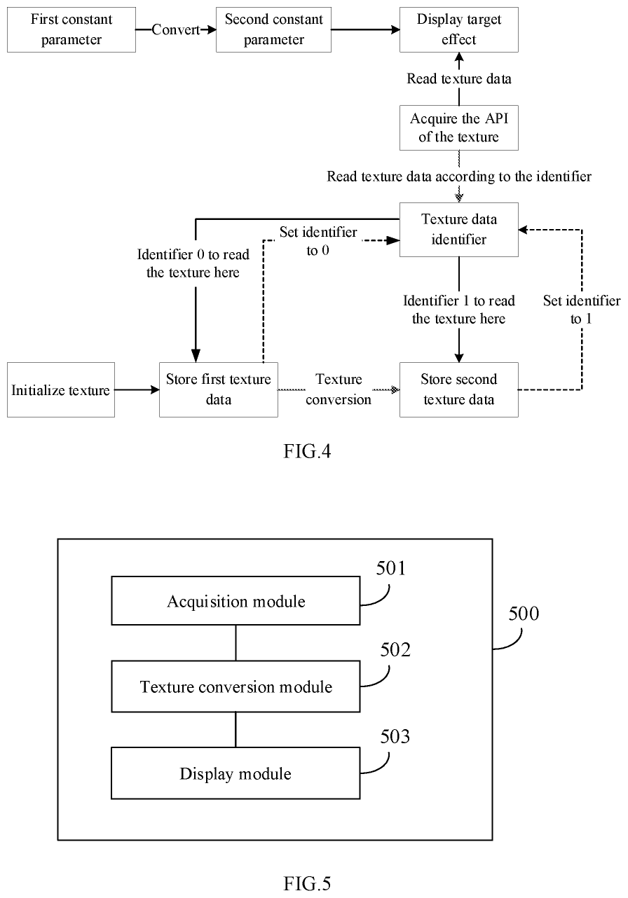

FIG. 4 is a flowchart of an image processing method provided by another embodiment of the present disclosure. Referring to FIG. 4, the electronic device acquires the resource package of the target effect and parses the resource package of the target effect, initializes the texture, and then loads the first texture data obtained by parsing into the memory. In practical application, the electronic device may allocate the corresponding memory resources for the first texture data, and this part of memory resources may be marked as the first memory space.

It should be understood that other data besides the texture data comprised in the resource package of the target effects are also loaded into the memory. Wherein, this part of data may include a first constant parameter.

The texture conversion of the first texture data may refer to the related descriptions in the embodiments shown in FIGS. 1 to 3, which are not repeated here for brevity.

In this scheme, the electronic device may also convert the first constant parameter. Specifically, the electronic device may read the first constant parameter and convert the first constant parameter based on the conversion function corresponding to the target output format to acquire the second constant parameter corresponding to the first constant parameter; the electronic device may write the second constant parameter into the memory to replace the first constant parameter.

If all the first texture data are subjected to texture conversion, the API for acquiring texture data is configured according to the corresponding second identifier of the second texture data. The electronic device accesses and reads the second texture data through the configured API for acquiring the texture data; and displaying the target effect according to the second texture data, the second constant parameter stored in the memory and other relevant information in the resource package corresponding to the target effect.

If a part of the first texture data is subjected to texture conversion, the API for acquiring the texture data is configured according to the first identifier corresponding to the data not subjected to texture conversion in the first texture data and the second identifier corresponding to the second texture data. The electronic device reads the data without the texture conversion in the first texture data from the first memory space through the configured API for acquiring the texture data, and the electronic device reads the second texture data from the second memory space through the configured API for acquiring the texture data; and display the target effect according to the data without the texture conversion in the first texture data, the second texture data, the second constant parameter stored in the memory and other relevant information in the resource package corresponding to the target effect.

Through the method of the embodiment shown in FIG. 4, online conversion of the SDR effects may be realized, which may save lots of offline conversion workloads, improve processing efficiency, and will not affect the performance of electronic device; in addition, this scheme will not have any impact on the use of effects currently deployed online. By converting the first constant parameter of the target effect, the accuracy of converting the target effect from the first color display standard to the second color display standard is improved.

The embodiment shown in FIG. 4 is similar to the embodiment shown in FIG. 2 above, and the class for storing the data type identifier is encapsulated in the API for acquiring the texture; in practical application, the class used to store the data type identifier may also be set separately, that is, it is not bound to the API, in this case, the API for acquiring texture acquires the identifier information by accessing the class for storing the data type identifier. The present disclosure does not restrict whether the class for storing data type identifier is bound to the API for acquiring texture.

In addition, it should be noted that, on the basis of the above-mentioned embodiments shown in FIGS. 1 to 4, in some scenarios, such as target effect 1 is currently being used, and then the electronic device detects the triggering operation for target effect 2 input by the user, the electronic device may delete the memory resources occupied by target effect 1 and allocate memory resources for target effect 2, so as to realize online conversion of target effect 2. Because the online texture conversion and the constant parameter conversion of electronic device require less computing resources and memory resources, it will not affect the performance of electronic device.

Illustratively, the present disclosure also provides an image processing apparatus.

FIG. 5 is a schematic structural diagram of an image processing apparatus provided by an embodiment of the present disclosure. Referring to FIG. 5, an image processing apparatus 500 provided in this embodiment comprises:
an acquisition module 501, configured to acquire a first texture data corresponding to a target effect in response to a triggering operation to the target effect, wherein the first texture data is a texture data of the target effect corresponding to a first color display standard;
a texture conversion module 502, configured to execute a texture conversion on the first texture data according to a second color display standard to acquire a second texture data; wherein the color range of the second color display standard is larger than a color range of the first color display standard; and
a display module 503, configured to display the target effect according to the second texture data.

In some possible embodiments, the texture conversion module 502 is configured to acquire a target output format of the target effect in the second color display standard, wherein the second color display standard corresponds to one or more output formats, and the one or more output formats comprise the target output format; and execute the texture conversion on the first texture data according to the target output format to acquire the second texture data.

In some possible embodiments, the texture conversion module 502 is configured to acquire a conversion function corresponding to the target output format according to the target output format; and execute the texture conversion on the first texture data according to the conversion function corresponding to the target output format to acquire the second texture data.

In some possible embodiments, the texture conversion module 502 is configured to configure a data type identifier corresponding to the second texture data; and acquire the second texture data according to the data type identifier of the second texture data.

In some possible embodiments, the texture conversion module 502 is specifically configured to execute the texture conversion on part of the first texture data according to the second color display standard to acquire the second texture data.

Accordingly, the display module 503 may be configured to display the target effect according to a texture data without the texture conversion in the first texture data and the second texture data, so as to add the target effect to the image material to be processed.

In some possible embodiments, the texture conversion module 502 is further configured to respectively configure data type identifiers corresponding to the texture data without the texture conversion in the first texture data and the second texture data; and acquire the texture data without the texture conversion in the first texture data and the second texture data according to the data type identifiers corresponding to the texture data without the texture conversion in the first texture data and the second texture data respectively.

In some possible embodiments, the acquisition module 501 is further configured to acquire a first constant parameter corresponding to the target effect; the texture conversion module 502 is further configured to convert the first constant parameter into a second constant parameter according to the second color display standard.

Correspondingly, the display module 503 is further configured to display the target effect according to the second texture data and the second constant parameter.

In some possible embodiments, the texture conversion module 502 is specifically configured to convert the first constant parameter into the second constant parameter according to a conversion function corresponding to the target output format of the target effect in the second color display standard.

In some possible embodiments, the first color display standard comprises a Standard Dynamic Range (SDR) color display standard, and the second color display standard comprises a High Dynamic Range (HDR) color display standard.

The image processing apparatus provided by an embodiment of the present disclosure is used to realize the technical scheme of any of the above-mentioned method embodiments, and its implementation principle and technical effect are similar. Please refer to the detailed description of the above-mentioned method embodiments, and for brevity, they will not be repeated here.

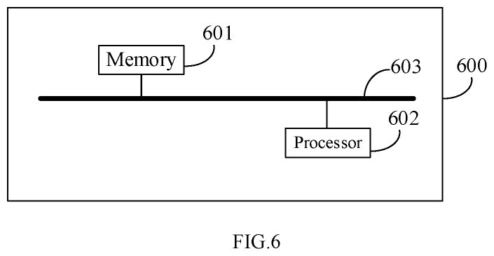

FIG. 6 is a schematic structural diagram of an electronic device provided by an embodiment of the present disclosure. Referring to FIG. 6, an electronic device 600 provided by this embodiment comprises a memory 601 and a processor 602.

The memory 601 may be an independent physical unit and may be connected with the processor 602 through a bus 603. The memory 601 and the processor 602 may also be integrated and realized by hardware.

The memory 601 is configured to store computer program instructions, and the processor 602 calls the computer program instructions to execute the operations of any of the above method embodiments.

Alternatively, when part or all of the methods in the above embodiments are implemented by software, the above electronic device 600 may only comprise the processor 602. The memory 601 for storing programs is located outside the electronic device 600, and the processor 602 is connected with the memory through circuits/wires for reading and executing computer program instructions stored in the memory.

The processor 602 may be a central processing unit (CPU), a network processor (NP) or a combination of CPU and NP.

The processor 602 may further include a hardware chip. The hardware chip may be an application-specific integrated circuit (ASIC), a programmable logic device (PLD) or a combination thereof. The PLD may be a complex programmable logic device (CPLD), a field-programmable gate array (FPGA), a generic array logic (GAL) or any combination thereof.

The memory 601 may comprise a volatile memory, such as a random-access memory (RAM). The memory may also comprise a non-volatile memory, such as a flash memory, a hard disk drive (HDD) or a solid-state drive (SSD). The memory may also comprise a combination of the above kinds of memories.

The present disclosure also provides a computer readable storage medium (which may also be called a readable storage medium), and the computer readable storage medium comprises computer program instructions, which, when executed by at least one processor of an electronic device, execute the image processing method provided by any of the above method embodiments.

The present disclosure also provides a program product, which comprises computer program instructions stored in a readable storage medium, from which at least one processor of the electronic device may read the computer program instructions, and the at least one processor executes the computer program instructions to cause the electronic device to execute the image processing method provided in any method embodiment.

It should be noted that in this paper, relational terms such as “first” and “second” are only used to distinguish one entity or operation from another entity or operation, and do not necessarily require or imply that there is any such actual relationship or order between these entities or operations. Moreover, the terms “include”, “comprise” or any other variation thereof are intended to cover non-exclusive inclusion, so that a process, method, article or device including a series of elements includes not only those elements, but also other elements not explicitly listed or elements inherent to such process, method, article or device. Without further restrictions, an element defined by the phrase “including a/an . . . ” does not exclude the existence of other identical elements in the process, method, article or device including the element.

What has been described above is only the specific embodiment of the present disclosure, so that those skilled in the art may understand or realize the present disclosure. Many modifications to these embodiments will be obvious to those skilled in the art, and the general principles defined herein may be implemented in other embodiments without departing from the spirit or scope of this disclosure. Therefore, the present disclosure will not be limited to the embodiments described herein, but is to be accorded the widest scope consistent with the principles and novel features disclosed herein.

1. An image processing method, comprising:
acquiring a first texture data corresponding to a target effect in response to a triggering operation to the target effect, wherein the first texture data is a texture data of the target effect corresponding to a first color display standard;
executing a texture conversion on the first texture data according to a second color display standard to acquire a second texture data; wherein a color range of the second color display standard is larger than a color range of the first color display standard; and
displaying the target effect according to the second texture data.

2. The method according to claim 1, wherein the executing the texture conversion on the first texture data according to the second color display standard to acquire the second texture data, comprises:
acquiring a target output format of the target effect in the second color display standard, wherein the second color display standard corresponds to one or more output formats, and the one or more output formats comprise the target output format; and
executing the texture conversion on the first texture data according to the target output format to acquire the second texture data.

3. The method according to claim 2, wherein the executing the texture conversion on the first texture data according to the target output format to acquire the second texture data, comprises:
acquiring a conversion function corresponding to the target output format according to the target output format; and
executing the texture conversion on the first texture data according to the conversion function corresponding to the target output format to acquire the second texture data.

4. The method according to claim 1, wherein before displaying the target effect according to the second texture data, further comprises:
configuring a data type identifier corresponding to the second texture data; and
acquiring the second texture data according to the data type identifier of the second texture data.

5. The method according to claim 1, wherein the executing the texture conversion on the first texture data according to the second color display standard to acquire the second texture data, comprises:
executing the texture conversion on part of the first texture data according to the second color display standard to acquire the second texture data; and
the displaying the target effect according to the second texture data, comprises:
displaying the target effect according to a texture data without the texture conversion in the first texture data and the second texture data.

6. The method according to claim 5, wherein before the displaying the target effect according to the texture data without the texture conversion in the first texture data and the second texture data, further comprises:
respectively configuring data type identifiers corresponding to the texture data without the texture conversion in the first texture data and the second texture data; and
acquiring the texture data without the texture conversion in the first texture data and the second texture data according to the data type identifiers corresponding to the texture data without the texture conversion in the first texture data and the second texture data respectively.

7. The method according to claim 1, wherein the method further comprises:
acquiring a first constant parameter corresponding to the target effect;
converting the first constant parameter into a second constant parameter according to the second color display standard; and
the displaying the target effect according to the second texture data, comprises:
displaying the target effect according to the second texture data and the second constant parameter.

8. The method according to claim 7, wherein the converting the first constant parameter into the second constant parameter according to the second color display standard, comprises:
converting the first constant parameter into the second constant parameter according to a conversion function corresponding to the target output format of the target effect in the second color display standard.

9. The method according to claim 1, wherein the first color display standard comprises a Standard Dynamic Range (SDR) color display standard, and the second color display standard comprises a High Dynamic Range (HDR) color display standard.

10. An image processing apparatus, comprising:
an acquisition module, configured to acquire a first texture data corresponding to a target effect in response to a triggering operation to the target effect, wherein the first texture data is a texture data of the target effect corresponding to a first color display standard;
a texture conversion module, configured to execute a texture conversion on the first texture data according to a second color display standard to acquire a second texture data; wherein the color range of the second color display standard is larger than a color range of the first color display standard; and
a display module, configured to display the target effect according to the second texture data.

11. An electronic device, comprising: a memory and a processor, wherein
the memory is configured to store computer program instructions; and
the processor is configured to execute the computer program instructions to cause the electronic device to:
acquire a first texture data corresponding to a target effect in response to a triggering operation to the target effect, wherein the first texture data is a texture data of the target effect corresponding to a first color display standard;
execute a texture conversion on the first texture data according to a second color display standard to acquire a second texture data; wherein a color range of the second color display standard is larger than a color range of the first color display standard; and
display the target effect according to the second texture data.

12. A non-transient readable storage medium, comprising: computer program instructions, wherein
the computer program instructions when executed by at least a processor of an electronic device to implement the image processing method according to claim 1.

13. A program product, comprising: computer program instructions, wherein
the computer program instructions are stored in a readable storage medium, and at least a processor of an electronic device can read the computer program instructions from the readable storage medium, and the at least one processor executes the computer program instructions to enable the electronic device to realize the image processing method according to claim 1.

14. The electronic device according to claim 11, wherein the executing the texture conversion on the first texture data according to the second color display standard to acquire the second texture data, comprises:
acquiring a target output format of the target effect in the second color display standard, wherein the second color display standard corresponds to one or more output formats, and the one or more output formats comprise the target output format; and
executing the texture conversion on the first texture data according to the target output format to acquire the second texture data.

15. The electronic device according to claim 14, wherein the executing the texture conversion on the first texture data according to the target output format to acquire the second texture data, comprises:
acquiring a conversion function corresponding to the target output format according to the target output format; and
executing the texture conversion on the first texture data according to the conversion function corresponding to the target output format to acquire the second texture data.

16. The electronic device according to claim 11, wherein before displaying the target effect according to the second texture data, further comprises:
configuring a data type identifier corresponding to the second texture data; and
acquiring the second texture data according to the data type identifier of the second texture data.

17. The electronic device according to claim 11, wherein the executing the texture conversion on the first texture data according to the second color display standard to acquire the second texture data, comprises:
executing the texture conversion on part of the first texture data according to the second color display standard to acquire the second texture data; and
the displaying the target effect according to the second texture data, comprises:
displaying the target effect according to a texture data without the texture conversion in the first texture data and the second texture data.

18. The electronic device according to claim 17, wherein before the displaying the target effect according to the texture data without the texture conversion in the first texture data and the second texture data, further comprises:
respectively configuring data type identifiers corresponding to the texture data without the texture conversion in the first texture data and the second texture data; and
acquiring the texture data without the texture conversion in the first texture data and the second texture data according to the data type identifiers corresponding to the texture data without the texture conversion in the first texture data and the second texture data respectively.

19. The electronic device according to claim 11, wherein the method further comprises:
acquiring a first constant parameter corresponding to the target effect;
converting the first constant parameter into a second constant parameter according to the second color display standard; and
the displaying the target effect according to the second texture data, comprises:
displaying the target effect according to the second texture data and the second constant parameter.

20. The electronic device according to claim 19, wherein the converting the first constant parameter into the second constant parameter according to the second color display standard, comprises:
converting the first constant parameter into the second constant parameter according to a conversion function corresponding to the target output format of the target effect in the second color display standard.
